(19) United States
(12) Patent Application Publication
(10) Pub. No.: US 2018/0329238 A1
(43) Pub. Date: Nov. 15, 2018

(54) LIQUID CRYSTAL MOLECULE ORIENTATION CONTROL METHOD AND LIQUID CRYSTAL DEVICE

(71) Applicant: THE DOSHISHA, Kyoto (JP)

(72) Inventors: Daisuke KOYAMA, Kyoto (JP); Satoki TANIGUCHI, Kyoto (JP); Yuki SHIMIZU, Kyoto (JP)

(73) Assignee: THE DOSHISHA, Kyoto (JP)

(21) Appl. No.: 15/768,328

(22) PCT Filed: Oct. 12, 2016
(86) PCT No.: PCT/JP2016/080215

§ 371 Date: Apr. 13, 2018

(30) Foreign Application Priority Data
Oct. 26, 2015 (JP) 2015-210025

(51) Int. Cl. G02F 1/1333; G02F 1/1337

(52) U.S. Cl. CPC G02F 1/1333; G02F 2001/133394; G02F 1/1337

(57) ABSTRACT

Provided are a liquid crystal molecule orientation control method and a liquid crystal device which render it possible to change the orientation of liquid crystal molecules without using an electric field. In controlling the orientation of liquid crystal molecules 103a, which are contained in a liquid crystal material 103 sandwiched between alignment films 104, by the liquid crystal molecule orientation control method, an ultrasonic wave is generated in a piezoelectric material 102 so as to propagate to the liquid crystal material 103, and static pressure is generated in accordance with the ultrasonic wave, with the result that the orientation is changed in accordance with the magnitude of the static pressure.

### TECHNICAL FIELD

The present invention relates to a liquid crystal molecule orientation control method and a liquid crystal device.

### BACKGROUND ART

In general, a liquid crystal device, such as a liquid crystal display, is structured by sandwiching a liquid crystal material (i.e., a liquid crystal layer) between pairs of alignment films, glass substrates, and transparent electrodes (see, for example, Patent Document 1). In the case of the liquid crystal device thus structured, the orientation of liquid crystal molecules contained in the liquid crystal material is changed by externally applying an electric field, thereby adjusting the amount of light to be transmitted through the liquid crystal material.

### PRIOR ART DOCUMENT

### Patent Document

Patent Document 1: Japanese Laid-Open Patent Publication No. 2001-11452

### DISCLOSURE OF THE INVENTION

### Problems to be Solved by the Invention

In the case of the liquid crystal device described in Patent Document 1, orientation control is performed using an electric field, as described above, and therefore, response speed for orientation change depends on physical properties (e.g., viscosity) of the liquid crystal material. Therefore, the liquid crystal device described in Patent Document 1 has difficulty in achieving high response speed depending on the physical properties of the liquid crystal material.

The present invention has been achieved under the above circumstances, with a problem thereof being to provide a liquid crystal molecule orientation control method and a liquid crystal device which render it possible to change the orientation of liquid crystal molecules without using an electric field.

### Solution to the Problems

To solve the aforementioned problem, the present invention provides a liquid crystal molecule orientation control method in which an ultrasonic wave is generated in a piezoelectric material so as to propagate to a liquid crystal material sandwiched between alignment films, thereby generating static pressure in accordance with the ultrasonic wave and changing an orientation of liquid crystal molecules contained in the liquid crystal material, in accordance with a magnitude of the static pressure.

In the liquid crystal molecule orientation control method, the liquid crystal material is sandwiched between an upper and lower pair of first and second transparent substrates without an intervening transparent electrode, the piezoelectric material is provided on either the first transparent substrate or the second transparent substrate, and the piezoelectric material is electrically driven with a resonant frequency of an entire combination of the liquid crystal material, the first transparent substrate, and the second transparent substrate, whereby the ultrasonic wave is generated in accordance with the resonant frequency so as to propagate to the liquid crystal material, the first transparent substrate, and the second transparent substrate.

In the liquid crystal molecule orientation control method, the piezoelectric material may include a first piezoelectric material and a second piezoelectric material, which are provided on opposite sides of the substrate on which the piezoelectric material is provided, and the ultrasonic wave may be generated in different phases between the first and second piezoelectric materials.

In the liquid crystal molecule orientation control method, the piezoelectric material is a piezoelectric substrate with an electrode formed on a surface, the liquid crystal material is provided on the surface of the piezoelectric substrate, and the piezoelectric substrate is electrically driven with a resonant frequency of the electrode, thereby generating the ultrasonic wave in accordance with the resonant frequency so as to propagate to the liquid crystal material.

Furthermore, to solve the aforementioned problem, the present invention also provides a liquid crystal device including a liquid crystal material sandwiched between alignment films, and a piezoelectric material that generates an ultrasonic wave upon application of an alternating-current voltage and allows the ultrasonic wave to propagate to the liquid crystal material, and the liquid crystal material allows static pressure to be generated in accordance with the ultrasonic wave that is propagating to the liquid crystal material, whereby a liquid crystal molecule orientation varies depending on whether the ultrasonic wave is propagating or not propagating to the liquid crystal material.

The liquid crystal device includes a first transparent substrate and a second transparent substrate disposed on opposite sides with the liquid crystal material sandwiched therebetween, no transparent electrode for applying a voltage to the liquid crystal material is provided, and the piezoelectric material is provided on either the first transparent substrate or the second transparent substrate, such that the ultrasonic wave propagates to the liquid crystal material, the first transparent substrate, and the second transparent substrate.

In the liquid crystal device, the piezoelectric material is a piezoelectric substrate with an electrode formed on a surface, the liquid crystal material is provided on the surface of the piezoelectric substrate, and the piezoelectric substrate generates the ultrasonic wave upon application of an alternating-current voltage to the electrode and allows the ultrasonic wave to propagate to the liquid crystal material.

### Effect of the Invention

The present invention makes it possible to provide a liquid crystal molecule orientation control method and a liquid crystal device which allows the orientation of liquid crystal molecules to be changed without using an electric field.

### BRIEF DESCRIPTION OF THE DRAWINGS

FIG. 1(A) is a view illustrating a liquid crystal device according to a first embodiment of the present invention.

FIG. 1(B) is an enlarged view of circled portion B in FIG. 1(A).

FIG. 2 is a diagram illustrating a system for measuring transmission light distribution in the present invention.

FIG. 3 is a graph showing vibrational distribution and transmission light distribution in the present invention.

FIG. 4 is a graph showing transmission light distribution in the present invention where an alternating-current signal is changed.

FIG. 5 is a graph showing time response for transmission light in the present invention.

FIG. 6(A) is a view illustrating a liquid crystal device according to a second embodiment of the present invention.

FIG. 6(B) is an enlarged view of circled portion B in FIG. 6(A).

### MODE FOR CARRYING OUT THE INVENTION

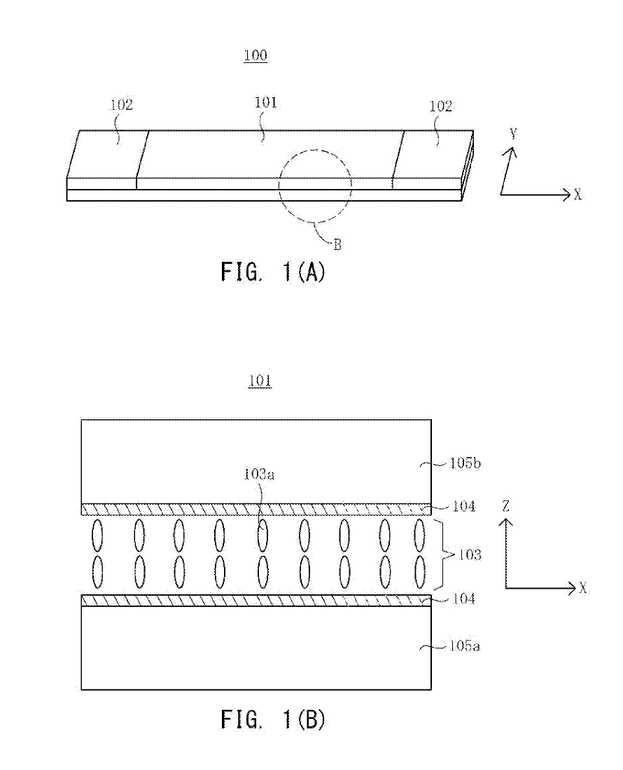

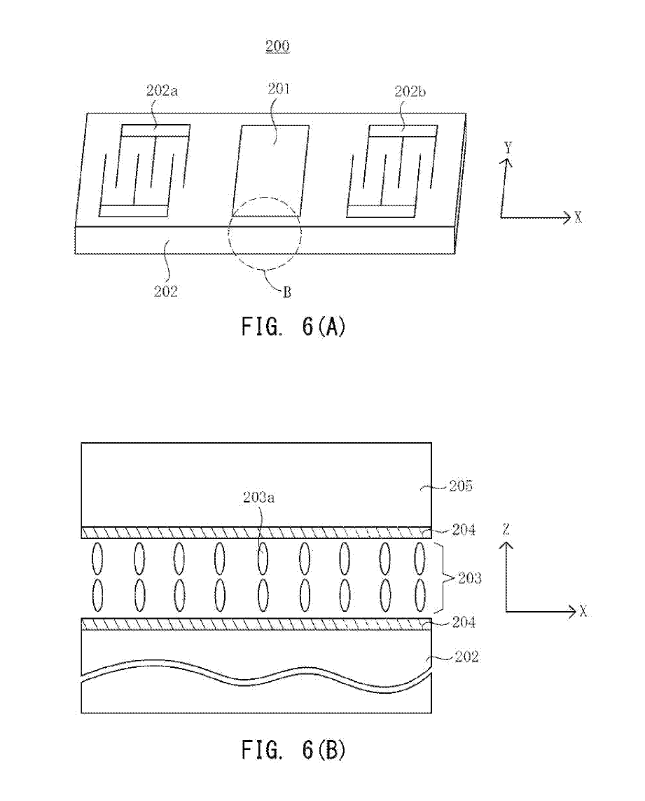

Hereinafter, embodiments of a liquid crystal molecule orientation control method and a liquid crystal device according to the present invention will be described with reference to the accompanying drawings. Note that in a first embodiment, the X-axis, Y-axis, and Z-axis directions in FIG. 1 correspond to lengthwise, widthwise, and thickness-wise directions, respectively. In a second embodiment, the X-axis, Y-axis, and Z-axis directions in FIG. 6 correspond to lengthwise, widthwise, and thickness-wise directions, respectively.

### First Embodiment

### (Liquid Crystal Device)

FIGS. 1(A) and 1(B) illustrate a liquid crystal device 100 according to the first embodiment of the present invention. The liquid crystal device 100 includes a liquid crystal cell 101 and two piezoelectric materials 102, as shown in FIG. 1(A).

The liquid crystal cell 101 includes a liquid crystal layer 103, which corresponds to a “liquid crystal material” of the present invention, an upper and lower pair of alignment films 104, a first transparent substrate 105a, and a second transparent substrate 105b, as shown in FIG. 1(B).

The liquid crystal layer 103 contains liquid crystal molecules 103a, more specifically, nematic liquid crystal molecules with a negative dielectric anisotropy. The liquid crystal layer 103 is sandwiched between the upper and lower pair of alignment films 104 so as to have a thickness of 5 μm, and is sealed therearound by a sealing material (not shown).

The upper and lower pair of alignment films 104 are homeotropic alignment films which cause the liquid crystal molecules 103a to have a pretilt angle of 90 degrees. The alignment films 104 are made of a polyimide-based material. The liquid crystal layer 103 is sandwiched between the upper and lower pair of alignment films 104, with the result that the liquid crystal molecules 103a in the liquid crystal layer 103 originally stand upright to the alignment films 104.

The first transparent substrate 105a and the second transparent substrate 105b sandwich the liquid crystal layer 103 and the upper and lower pair of alignment films 104 without an intervening transparent electrode. Both the first transparent substrate 105a and the second transparent substrate 105b are transparent glass substrates through which light is transmitted.

The first transparent substrate 105a has a length of 50 mm, a width of 10 mm, and a thickness of 1 mm. The second transparent substrate 105b has a length of 30 mm, a width of 10 mm, and a thickness of 1 mm. The liquid crystal layer 103 and the upper and lower pair of alignment films 104 are 30-mm long or shorter. The liquid crystal layer 103, the upper and lower pair of alignment films 104, and the second transparent substrate 105b are provided on or above a center portion (having a length of 30 mm) of the first transparent substrate 105a, which excludes opposite end portions (each having a length of 10 mm measured from its corresponding end of the first transparent substrate 105a).

The piezoelectric materials 102 are provided on their respective end portions of the first transparent substrate 105a so as to sandwich the liquid crystal layer 103 and the upper and lower pair of alignment films 104 lengthwise. The piezoelectric materials 102 are firmly fixed to the first transparent substrate 105a by epoxy resin. The piezoelectric materials 102 are ultrasonic oscillators, each being made with lead zirconate titanate (PZT) and having a length of 10 mm, a width of 10 mm, and a thickness of 1 mm. Upon application of an alternating-current signal at a certain frequency, the piezoelectric material 102 generates an ultrasonic wave in accordance with that frequency.

In the present embodiment, an alternating-current signal at a resonant frequency of the entire liquid crystal cell 101 is applied to the piezoelectric material 102, thereby generating an ultrasonic wave in accordance with the resonant frequency. Since the piezoelectric material 102 is provided on the first transparent substrate 105a, as mentioned earlier, the ultrasonic wave generated in the piezoelectric material 102 propagates through the first transparent substrate 105a to the liquid crystal layer 103. At this time, in the liquid crystal cell 101, bending vibrations occur lengthwise in accordance with the ultrasonic wave. In the liquid crystal layer 103, an acoustic standing wave is generated in accordance with the bending vibrations, with the result that an acoustic radiation force (static pressure) acts on interfaces of the liquid crystal layer 103. At antinodes of the acoustic standing wave, i.e., at portions where the acoustic radiation force is high, the force that acts on the liquid crystal molecules 103a is also high, and therefore, the orientation of the liquid crystal molecules 103a that are present in such portions changes.

In summary, in the case of the liquid crystal device 100 according to the present embodiment, the orientation of the liquid crystal molecules 103a is not changed by an electric field but is forcibly changed by an acoustic radiation force (static pressure) in accordance with an ultrasonic wave. Therefore, when compared to liquid crystal devices that perform orientation control using an electric field, the liquid crystal device 100 according to the present embodiment is more capable of achieving a high response speed in relation to orientation change.

Furthermore, the liquid crystal device 100 according to the present embodiment does not perform orientation control using an electric field, as mentioned earlier, and therefore, dispenses with a transparent electrode as used in a typical liquid crystal device. For such a transparent electrode, a minor metal is often used, and therefore, there might arise some problems such as cost increase due to price fluctuations and supply shortage due to resource depletion, but the liquid crystal device 100 according to the present embodiment has no such problems because no transparent electrode is included.

### (Liquid Crystal Molecule Orientation Control Method)

Next, a liquid crystal molecule orientation control method according to the first embodiment of the present invention will be described.

In the liquid crystal molecule orientation control method according to the present embodiment, ultrasonic waves are generated in the piezoelectric materials so as to propagate to the liquid crystal material sandwiched between the alignment films and thereby generate acoustic radiation forces (static pressure) in accordance with the ultrasonic waves, with the result that the orientation of the liquid crystal molecules contained in the liquid crystal material is changed.

Specifically, to allow the ultrasonic waves generated in the piezoelectric materials to propagate to the liquid crystal material, initially, a liquid crystal device is produced such that the piezoelectric materials and the liquid crystal material are provided on the same substrate, or a liquid crystal device thus produced is prepared. That is, the liquid crystal device 100 is produced or prepared.

Next, an alternating-current signal at a predetermined frequency is applied to the piezoelectric material, thereby generating an ultrasonic wave in the piezoelectric material. So long as static pressure in accordance with the ultrasonic wave can be generated in the liquid crystal material, any frequency can be employed, but preferably, the frequency is a resonant frequency of the entire liquid crystal cell including the liquid crystal material. More specifically, in the case of the liquid crystal device 100, it is preferable that the ultrasonic wave be generated in the piezoelectric material 102 by applying to the piezoelectric material 102 an alternating-current signal at a frequency obtained by combining a resonant frequency of the liquid crystal layer 103 sandwiched between the alignment films 104, a resonant frequency of the first transparent substrate 105a, and a resonant frequency of the second transparent substrate 105b.

Then, the alternating-current signal is controlled as necessary. Specifically, by changing a peak-to-peak voltage value Vpp and/or the frequency of the alternating-current signal, the acoustic radiation force (static pressure) can be changed, with the result that the orientation of the liquid crystal molecules can be changed.

Taking the liquid crystal device 100 as an example, the alternating-current signal applied to the piezoelectric material 102 and the acoustic standing wave, i.e., the acoustic radiation force (static pressure), generated in the liquid crystal layer 103 have a certain relationship. As the peak-to-peak voltage value Vpp of the alternating-current signal increases, the acoustic radiation force (static pressure) increases, whereby the degree of the orientation change of the liquid crystal molecules 103a increases. On the other hand, as the peak-to-peak voltage value Vpp of the alternating-current signal decreases, the acoustic radiation force (static pressure) decreases, whereby the degree of the orientation change of the liquid crystal molecules 103a decreases.

In the liquid crystal layer 103, the acoustic standing wave in accordance with the frequency of the alternating-current signal is generated, and the acoustic radiation force (static pressure) is maximized at antinodes of the acoustic standing wave and minimized at nodes of the acoustic standing wave. Accordingly, by changing the frequency of the alternating-current signal, the locations of the antinodes and the nodes of the acoustic standing wave are shifted, with the result that intensity distribution of the acoustic radiation force (static pressure) changes. Consequently, the orientation of the liquid crystal molecules 103a changes as well. Moreover, the locations of the antinodes and the nodes of the acoustic standing wave can be shifted also by shifting the phase of an alternating-current signal applied to one piezoelectric material 102 relative to the phase of an alternating-current signal applied to the other piezoelectric material 102, instead of changing the frequency of the alternating-current signal.

### (Evaluation Experiments)

Next, evaluation experiments (first through third evaluation experiments) will be described with respect to the liquid crystal molecule orientation control method using the liquid crystal device 100. Some descriptions that are common among the evaluation experiments will be omitted.

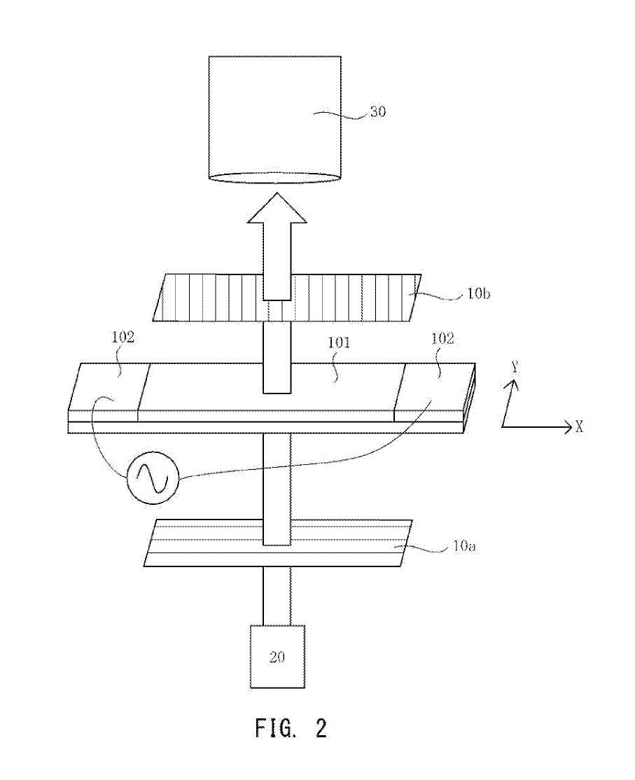

Initially, in the first evaluation experiment, the intensity of transmission light through the liquid crystal cell 101 was measured, and the distribution of the transmission light was compared to the vibrational distribution of the liquid crystal cell 101. FIG. 2 illustrates a measurement system for measuring the intensity of transmission light.

As shown in the figure, the liquid crystal cell 101 was placed between two polarizers 10a and 10b disposed in a crossed-Nicols arrangement, a laser light source 20, which was disposed on the polarizer 10a side, irradiated the liquid crystal cell 101 with a laser beam thickness-wise (i.e., in the direction from the polarizer 10a toward the polarizer 10b), in a state where alternating-current signals were being applied to the piezoelectric materials 102 (i.e., the piezoelectric materials 102 were being electrically driven by the alternating-current signals), and the laser beam (transmission light) passed through the polarizers 10a and 10b and the liquid crystal cell 101 was detected using a light detector 30 disposed on the polarizer 10b side. The laser light source 20 used was an He—Ne laser adapted to irradiate a laser beam having a wavelength of 632.8 nm. The alternating-current signals applied were signals (alternating-current voltages), each having a peak-to-peak voltage value Vpp of 10V and a frequency of 214 kHz. Moreover, the alternating-current signal applied to one piezoelectric material 102 and the alternating-current signal applied to the other piezoelectric material 102 were matched in phase.

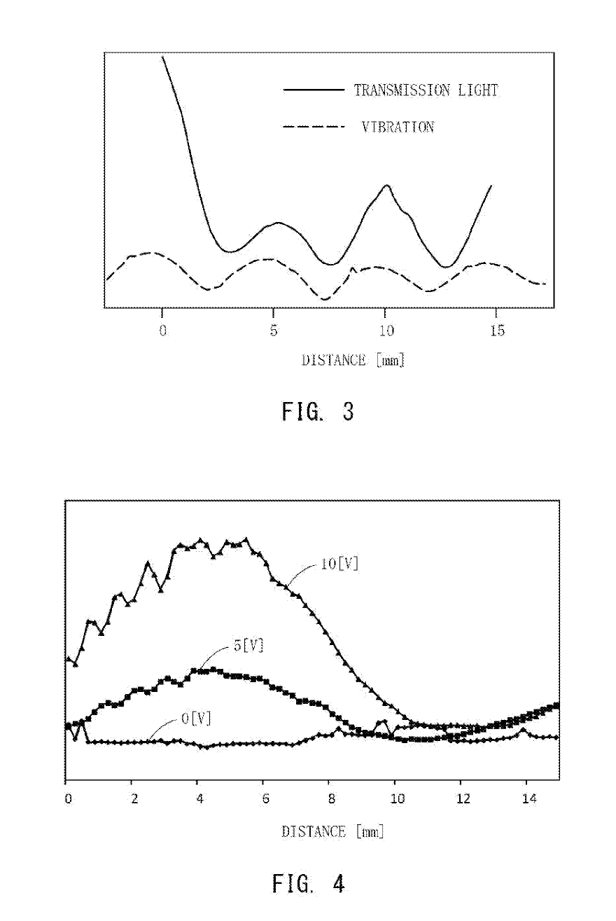

FIG. 3 shows comparison results between the vibrational distribution and the transmission light distribution. In FIG. 3, the transmission light distribution is represented by a solid line, and the vibrational distribution is represented by a dotted line. Moreover, the vertical axis represents intensity for both vibration (i.e., bending vibration) and transmission light, and the horizontal axis represents distance in the longitudinal direction of the liquid crystal cell 101. Note that the center of the liquid crystal cell 101 corresponds to the distance of 0 mm.

To look at the vibrational distribution, the vibration intensity is high around the distances of 0 mm, 5 mm, 10 mm, and 15 mm and low around the distances of 2.5 mm, 7.5 mm, and 12.5 mm. In the liquid crystal layer 103, since the acoustic standing wave is generated in accordance with bending vibrations, it can be conceived that the acoustic radiation force (static pressure) is high around the distances of 0 mm, 5 mm, 10 mm, and 15 mm and low around the distances of 2.5 mm, 7.5 mm, and 12.5 mm.

To look at the transmission light distribution, the intensity of transmission light tends to increase and decrease in a pattern similar to the pattern of the vibrational distribution, with slight deviations between the patterns. From this, it can be conceived that the degree of orientation change of the liquid crystal molecules 103a is related to the vibration intensity, i.e., the magnitude of the acoustic radiation force (static pressure). Specifically, it can be conceived that as the acoustic radiation force (static pressure) increases, the degree of the orientation change of the liquid crystal molecules 103a increases, whereby the intensity of transmission light increases, and that as the acoustic radiation force (static pressure) decreases, the degree of the orientation change of the liquid crystal molecules 103a decreases, whereby the intensity of transmission light decreases.

Although not shown in the figure, there was some small amplitude appearing over the transmission light distribution where no alternating-current signal was being applied. The reason for this, conceivably, is that the orientation of the liquid crystal molecules 103a was not completely homeotropic so that some components were not cut off by the polarizers 10a and 10b.

Next, in the second evaluation experiment, the intensity of transmission light through the liquid crystal cell 101 was measured by the measurement system in FIG. 2, where only the voltage value of the alternating-current signal was changed. Specifically, the intensity of the transmission light was measured for the cases where the peak-to-peak voltage value Vpp of the alternating-current signal was 0V, 5V, or 10V. The results are shown in FIG. 4. In FIG. 4, the vertical axis represents transmission light intensity, and the horizontal axis represents distance from a predetermined position in the longitudinal direction of the liquid crystal cell 101.

Referring to FIG. 4, the maximum value of the transmission light intensity increases with the peak-to-peak voltage value Vpp of the alternating-current signal. For example, around the distance of 4 mm, the transmission light intensity where the peak-to-peak voltage value Vpp of the alternating-current signal is 10V, is increased by about 720% compared to that where the peak-to-peak voltage value Vpp of the alternating-current signal is 0V. From this, it can be conceived that as the peak-to-peak voltage value Vpp of the alternating-current signal increases, the degree of the orientation change of the liquid crystal molecules 103a increases as well.

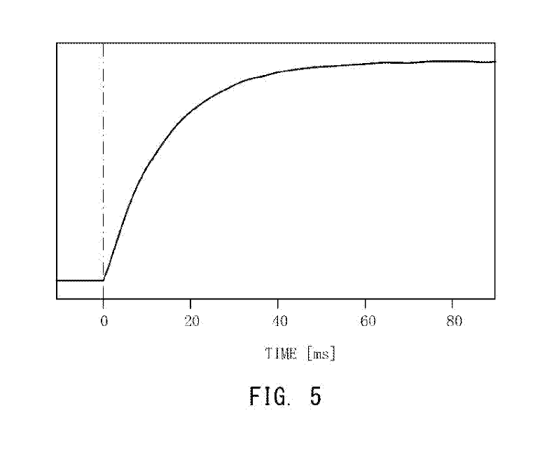

Lastly, in the third evaluation experiment, time response for transmission light was measured by the measurement system in FIG. 2. The results are shown in FIG. 5. In FIG. 5, the vertical axis represents transmission light intensity, and the horizontal axis represents time elapsed after input of the alternating-current signal. The alternating-current signal applied was a signal (alternating-current voltage) having a peak-to-peak voltage value Vpp of 10V and a frequency of 214 kHz.

The time constant τ of a time response curve shown in FIG. 5 was 16 ms. Moreover, the response time (i.e., the time taken for stabilizing the transmission light intensity) was about 60 ms.

### Second Embodiment

### (Liquid Crystal Device)

FIGS. 6(A) and 6(B) illustrate a liquid crystal device 200 according to the second embodiment of the present invention.

The liquid crystal device 200 includes a liquid crystal cell 201 and a piezoelectric substrate 202, which corresponds to a “piezoelectric material” of the present invention, as shown in FIG. 6(A). In the present embodiment, the liquid crystal cell 201 is provided on a top surface of the piezoelectric substrate 202.

The liquid crystal cell 201 includes a liquid crystal layer 203, which corresponds to a “liquid crystal material” of the present invention, an upper and lower pair of alignment films 204, and a transparent substrate 205, as shown in FIG. 6(B). When compared to the liquid crystal cell 101 in the first embodiment, the liquid crystal cell 201 is significantly compact. The liquid crystal layer 203, the alignment films 204, and the transparent substrate 205 have the same features as the liquid crystal layer 103, the alignment films 104, and the second transparent substrate 105b, respectively, in the first embodiment. For example, liquid crystal molecules 203a contained in the liquid crystal layer 203 are nematic liquid crystal molecules with a negative dielectric anisotropy, and originally stand upright to the alignment films 204.

The piezoelectric substrate 202 is, for example, a surface acoustic wave (SAW) filter and has comb-shaped electrodes (IDTs) 202a and 202b formed on the top surface. In order to transmit light, the piezoelectric substrate 202 is transparent at least where the liquid crystal cell 201 is provided. In the case of the piezoelectric substrate 202, when an alternating-current signal at a certain frequency (preferably, a resonant frequency of the comb-shaped electrodes 202a and 202b) is applied to the comb-shaped electrodes 202a and 202b, ultrasonic waves in accordance with that frequency are generated and propagate between the comb-shaped electrodes 202a and 202b.

In the present embodiment, since the liquid crystal cell 201 is provided on the top surface of the piezoelectric substrate 202, the ultrasonic waves generated in the piezoelectric substrate 202 propagate to the liquid crystal cell 201. In this case, bending vibrations in accordance with the ultrasonic waves occur in the liquid crystal cell 201 in the longitudinal direction thereof. In the liquid crystal layer 203, an acoustic standing wave in accordance with the bending vibrations is generated, with the result that an acoustic radiation force (static pressure) acts on interfaces of the liquid crystal layer 203. At antinodes of the acoustic standing wave, i.e., at portions where the acoustic radiation force is high, the force that acts on the liquid crystal molecules 203a is also high, and therefore, the orientation of the liquid crystal molecules 203a that are present in such portions changes.

In summary, in the case of the liquid crystal device 200 according to the present embodiment, the orientation of the liquid crystal molecules 203a is not changed by an electric field but is forcefully changed by an acoustic radiation force (static pressure) in accordance with an ultrasonic wave. Therefore, the liquid crystal device 200 according to the present embodiment is capable of achieving a high response speed in relation to orientation change, and further, dispenses with a transparent electrode as used in a typical liquid crystal device.

Furthermore, since the liquid crystal device 200 according to the present embodiment employs the configuration in which the liquid crystal cell 201 is provided on the top surface of the piezoelectric substrate 202, it is possible to realize a significantly compact device compared to the liquid crystal device 100 in the first embodiment.

### (Liquid Crystal Molecule Orientation Control Method)

Next, a liquid crystal molecule orientation control method according to the second embodiment of the present invention will be described.

In the liquid crystal molecule orientation control method according to the present embodiment, an ultrasonic wave is generated in the piezoelectric material so as to propagate to the liquid crystal material sandwiched between the alignment films, thereby generating an acoustic radiation force (static pressure) in accordance with the ultrasonic wave, with the result that the orientation of the liquid crystal molecules contained in the liquid crystal material is changed, as in the first embodiment.

Specifically, to allow the ultrasonic wave generated in the piezoelectric substrate 202 to propagate to the liquid crystal layer 203, initially, a liquid crystal device 200 is produced such that the liquid crystal layer 203 is provided above the piezoelectric substrate 202, or a liquid crystal device 202 thus produced is prepared.

Next, an alternating-current signal at a predetermined frequency (preferably, a resonant frequency of the comb-shaped electrodes 202a and 202b) is applied to the piezoelectric substrate 202, thereby generating an ultrasonic wave in the piezoelectric substrate 202. Then, the alternating-current signal is controlled as necessary. Specifically, by changing a peak-to-peak voltage value Vpp and/or the frequency of the alternating-current signal, the acoustic radiation force (static pressure) can be changed, with the result that the orientation of the liquid crystal molecules 203a can be changed. Note that the orientation change of the liquid crystal molecules 203a due to an ultrasonic wave occurs by the same mechanism as in the first embodiment, and therefore, any description thereof will be omitted.

While the embodiments of the liquid crystal device and the liquid crystal molecule orientation control method according to the present invention have been described above, the present invention is not limited to the embodiments.

### [Variants]

In the first embodiment, the liquid crystal layer 103, the alignment films 104, the first transparent substrate 105a, and the second transparent substrate 105b can be suitably changed in terms of structure, shape, size, material, etc., so long as the acoustic radiation force (static pressure) in accordance with the ultrasonic wave can be generated in the liquid crystal layer 103. The same applies to the second embodiment. For example, the liquid crystal layers 103 and 203 can also contain liquid crystal molecules other than nematic liquid crystal molecules with a negative dielectric anisotropy, and the alignment films 104 and 204 can also be alignment films other than homeotropic alignment films.

The piezoelectric material 102 in the first embodiment can be suitably changed in terms of structure, shape, size, substance, number, disposing location, etc. The piezoelectric material 202 in the second embodiment can be suitably changed in terms of structure, shape, size, substance, etc., as well as number, disposing location, etc., of the comb-shaped electrodes 202a and 202b. For example, in the first embodiment, the number of piezoelectric materials 102 may be one, and in the second embodiment, only one of the comb-shaped electrodes 202a and 202b may be provided.

The alternating-current signal that is to be applied to the piezoelectric material 102 or the piezoelectric substrate 202 can be suitably changed. For example, applying a high-frequency alternating-current signal renders it possible to perform detailed orientation control.

The liquid crystal device according to the present invention encompasses optical devices such as a varifocal lens and an optical scanner.

### DESCRIPTION OF THE REFERENCE CHARACTERS

100, 200 liquid crystal device

101, 201 liquid crystal cell

102, 202 piezoelectric material (piezoelectric substrate)

103, 203 liquid crystal layer

103a, 203a liquid crystal molecule

104, 204 alignment film

105a first transparent substrate

105b second transparent substrate

205 transparent substrate

1. A liquid crystal molecule orientation control method for controlling a liquid crystal molecule orientation, wherein,
an ultrasonic wave is generated in a piezoelectric material so as to propagate to a liquid crystal material sandwiched between alignment films, thereby generating static pressure in accordance with the ultrasonic wave and changing an orientation of liquid crystal molecules contained in the liquid crystal material, in accordance with a magnitude of the static pressure.

2. The liquid crystal molecule orientation control method according to claim 1, wherein,
the liquid crystal material is sandwiched between an upper and lower pair of first and second transparent substrates without an intervening transparent electrode,
the piezoelectric material is provided on either the first transparent substrate or the second transparent substrate, and
the piezoelectric material is electrically driven with a resonant frequency of an entire combination of the liquid crystal material, the first transparent substrate, and the second transparent substrate, whereby the ultrasonic wave is generated in accordance with the resonant frequency so as to propagate to the liquid crystal material, the first transparent substrate, and the second transparent substrate.

3. The liquid crystal molecule orientation control method according to claim 2, wherein,
the piezoelectric material includes a first piezoelectric material and a second piezoelectric material, the first and second piezoelectric materials being provided on opposite sides of the substrate on which the piezoelectric material is provided, and
the ultrasonic wave is generated in different phases between the first and second piezoelectric materials.

4. The liquid crystal molecule orientation control method according to claim 1, wherein,
the piezoelectric material is a piezoelectric substrate with an electrode formed on a surface,
the liquid crystal material is provided on the surface of the piezoelectric substrate, and
the piezoelectric substrate is electrically driven with a resonant frequency of the electrode, thereby generating the ultrasonic wave in accordance with the resonant frequency so as to propagate to the liquid crystal material.

5. A liquid crystal device comprising:
a liquid crystal material sandwiched between alignment films; and
a piezoelectric material that generates an ultrasonic wave upon application of an alternating-current voltage and allows the ultrasonic wave to propagate to the liquid crystal material, wherein,
the liquid crystal material allows static pressure to be generated in accordance with the ultrasonic wave that is propagating to the liquid crystal material, whereby a liquid crystal molecule orientation varies depending on whether the ultrasonic wave is propagating or not propagating to the liquid crystal material.

6. The liquid crystal device according to claim 5, comprising a first transparent substrate and a second transparent substrate disposed on opposite sides with the liquid crystal material sandwiched therebetween, wherein,
no transparent electrode for applying a voltage to the liquid crystal material is provided, and
the piezoelectric material is provided on either the first transparent substrate or the second transparent substrate, such that the ultrasonic wave propagates to the liquid crystal material, the first transparent substrate, and the second transparent substrate.

7. The liquid crystal device according to claim 5, wherein,
the piezoelectric material is a piezoelectric substrate with an electrode formed on a surface,
the liquid crystal material is provided on the surface of the piezoelectric substrate, and
the piezoelectric substrate generates the ultrasonic wave upon application of an alternating-current voltage to the electrode and allows the ultrasonic wave to propagate to the liquid crystal material.
